(19) United States
(12) Patent Application Publication
(10) Pub. No.: US 2010/0289785 A1
(43) Pub. Date: Nov. 18, 2010

(54) DISPLAY APPARATUS

(76) Inventor: Daiichi Sawabe, Tsu-shi Mie (JP)

Correspondence Address: HARNESS, DICKEY & PIERCE, P.L.C., P.O. BOX 8910, RESTON, VA, 20195, US

(21) Appl. No.: 12/309,473

(22) PCT Filed: May 11, 2007
(86) PCT No.: PCT/JP2007/059706

§ 371 Date: Jan. 21, 2009

(30) Foreign Application Priority Data
Sep. 15, 2006 (JP) 2006-25156

(51) Int. Cl. G09G 3/36; G06F 3/038

(52) U.S. Cl. 345/208; 345/94

(57) ABSTRACT

In one embodiment of the present invention, a display apparatus includes a liquid crystal display panel including: video signal lines to supply a data signal; scanning signal lines provided so as to intersect the video signal lines; and pixel electrodes provided at intersections of the video signal lines and the scanning signal lines via switching elements, respectively; and a scanning signal line drive circuit for supplying a scanning signal to each of the scanning signal lines. The display apparatus further includes a slope generating circuit which generates a falling slope signal in accordance with the signal delay transfer characteristic of the scanning signal lines, determined by the length of the display panel. The falling slope signal controls a scanning signal so that the scanning signal has a substantially equal slope at its fall regardless of its position on each scanning signal line. The falling slope signal is supplied to the scanning signal line drive circuit. The slope generating circuit includes an EEPROM which variably sets the timing of the rising edge of the scanning signal and the timing of the slope falling edge of the scanning signal.

### TECHNICAL FIELD

The present invention relates to a display apparatus including a display panel and a scanning signal line drive circuit for supplying scanning signals to scanning signal lines.

### BACKGROUND ART

Liquid crystal display apparatuses are widely used as display devices such as televisions and graphic displays. Among other liquid crystal display apparatuses, a liquid crystal display apparatus including a switching element such as a thin film transistor (hereinafter referred to as a TFT) for each display pixel is drawing particular attention. This is because such a liquid crystal display apparatus is, even though the number of display pixels increases, capable of providing superior display images which are free from cross talk between adjacent display pixels.

As illustrated in FIG. 13, such a liquid crystal display apparatus includes a liquid crystal display panel 110 and a drive circuit section as main sections. The liquid crystal display panel 110 includes: a pair of electrode substrates; a liquid crystal composition sandwiched between the pair of electrode substrates; and a polarizing plate attached to the outer surface of each of the pair of electrode substrates.

One of the pair of electrode substrates is a thin film transistor (TFT) array substrate, which includes: (i) a plurality of signal lines S(1), S(2), . . . S(i), . . . and S(N); and (ii) a plurality of scanning signal lines G(1), G(2), . . . G(j), . . . and G(M), in a matrix manner. The TFT array substrate further includes a switching element 102 which is made up of a TFT connected to a pixel electrode 103 and which is formed at each of the intersections of the signal lines and the scanning signal lines. The other electrode substrate includes a counter electrode 111.

The drive circuit section includes: a scanning signal line drive circuit 120 connected to the scanning signal lines; a signal line drive circuit 130 connected to the signal lines; and a counter electrode drive circuit COM connected to the counter electrode 111.

According to the drive circuit section having the above arrangement, during a first field (TF1), a TFT of a display pixel P(i, j) is changed into an ON state when a gate ON voltage Vgh is applied from the scanning signal line drive circuit 120 to a gate electrode g(i, j) of the TFT (see FIG. 14). This causes a video signal voltage Vsp of the signal line drive circuit 130 to be written into a corresponding pixel electrode 103, via a source electrode and a drain electrode of the TFT. The pixel electrode 101 maintains a pixel potential Vdp until a gate ON voltage Vgh is applied to the TFT during the following field (TF2). The counter electrode 111 is set to a predetermined counter potential VCOM by the counter electrode drive circuit COM. As a result, the liquid crystal composition sandwiched between the pixel electrode 101 and the counter electrode 111 responds to a potential difference between the pixel potential Vdp and the counter potential VCOM, whereby displaying of an image is carried out.

Similarly, during a second field (TF2), the TFT of the display pixel P(i, j) is changed into the ON state when the gate ON voltage Vgh is applied from the scanning signal line drive circuit 120 to the gate electrode g(i, j) of the TFT. This causes a video signal voltage Vsn of the signal line drive circuit 130 to be written into the corresponding pixel electrode. The pixel electrode maintains a pixel potential Vdn. As a result, the liquid crystal composition responds to a potential difference between the pixel potential Vdn and the counter potential VCOM, whereby displaying of an image is carried out. An AC driving of the liquid crystal is thus carried out.

Between the gate and the drain of the TFT, there is inevitably generated a parasitic capacitance Cgd due to the arrangement of the TFT. As shown in FIG. 14, the parasitic capacitance Cgd causes a level shift ΔVd in the pixel potential Vd at a falling edge of the gate ON voltage Vgh.

In a case where an attention is focused on a specific scanning signal line G(j), when a scanning voltage Vgh is applied from the scanning signal line drive circuit 120 to a scanning signal line G(j), a gate ON voltage Vgh is applied to gate electrodes g(1, j), g(2, j), g(3, j), . . . , g(i, j), . . . and g(N, j) on a j-th scanning signal line shown in FIG. 13.

An output of the gate ON voltage Vgh that has just been outputted from the scanning signal line drive circuit 120 has rectangular wave which rises perpendicularly at time t0 and falls perpendicularly at time t1 (see the waveform diagram of VG(j) in the upper part of FIG. 15). It is supposed for the rectangular wave to maintain the wave shape, which rises perpendicularly at time t0 and falls perpendicularly at time ti, at any of the gate electrodes g(1, j), g(2, j), g(3, j), . . . , g(i, j), . . . and g(N, j) on the j-th scanning signal line.

In actuality, however, there are provided, between the gate electrodes g(1, j) and g(N, j), (i) resistance components rg1, rg2, rg3, . . . and rgN generated due to the material, the width, and the length of a wire from which the scanning signal line is formed, and (ii) various parasitic capacitances cg1, cg2, cg3, . . . and cgN which have capacity coupling relation with the scanning signal line (see FIG. 16). This causes a signal to be transmitted with a delay.

As such, as illustrated in the middle part of FIG. 15, a gate voltage Vg(1, j) has waveform substantially identical to the waveform of VG(j) (see the upper part of FIG. 15), whereas a gate voltage Vg(N, j) has waveform which rises at time t0 curvilinearly, instead of perpendicularly, and falls at time t0 curvilinearly, instead of perpendicularly (see the middle part of FIG. 15). In other words, the signal waveform of the gate voltage Vg(N, j) is distorted.

In consequence, as illustrated in the middle part of FIG. 15, since the gate of a TFT is changed into an ON state in response to a gate voltage of not lower than a threshold voltage VT, a TFT which receives the gate voltage Vg(1, j) is turned on at time t0 and turned off at time t1. However, a TFT which receives the gate voltage Vg(N, j) is turned on at time t0′, which comes slightly later than the time t0, and turned off at time t1′, which comes slightly later than the time t1.

As to a pixel corresponding to the gate electrode g(1, j) to which an output has just been outputted from the scanning signal line drive circuit 120, a scanning signal falls from the gate ON voltage Vgh to the gate OFF voltage Vgl instantaneously. As such, a level shift ΔVd(1) generated in the pixel potential Vd(1, j) due to the parasitic capacitance Cgd can be approximated by the following formula:

ΔVd(1)=Cgd·(Vgh−Vgl)/(Clc+Cs+Cgd),

wherein, as illustrated in FIG. 17, Cgd represents parasitic capacitance between the gate and the drain of the TFT; Clc represents pixel capacitance; and Cs represents auxiliary capacitance.

In contrast, as to the pixel near the gate electrode g(N, j) which is a termination of the scanning signal line, the falling edge of a scanning signal is distorted. In consequence, the parasitic capacitance Cgd causes no level shift in the pixel potential Vd while the scanning signal falls from the gate ON voltage Vgh to the vicinity of the threshold voltage VT of the TFT because the TFT is then in the ON state. In contrast, the parasitic capacitance Cgd does cause a level shift ΔVd(N) in the pixel potential Vd(N, j), while the scanning signal further falls from the vicinity of the threshold voltage VT to the gate OFF voltage Vgl. Therefore, the level shift ΔVd(N) is defined by the following inequality:

ΔVd(N)<Cgd·(Vgh−Vgl)/(Clc+Cs+Cgd),

whereby ΔVd(1)>ΔVd(N) is satisfied.

As described above, the level shift ΔVd generated in the pixel potential Vd due to the parasitic capacitance Cgd in a panel is nonuniform over a display surface. This nonuniformity cannot be ignored when the screen is larger and has a higher resolution. A conventional method of biasing a counter voltage is incapable of absorbing the nonuniformity of the level shift over a display surface and therefore does not allow an optimal AC driving of each pixel to be carried out. This gives rise to defects such as occurrence of flickers and screen burn-in caused by an application of a DC component.

In order to solve the above problem, the applicants of the present invention disclose, in Patent Document 1, a technique in which a gate voltage Vg(1, j) of the gate electrode g(1, j) that has just been outputted from the scanning signal line drive circuit 120 is designed so as to intentionally fall along a slope of its falling edge to the gate OFF voltage (see FIG. 18). This allows the following two slopes to be substantially identical to each other: the slope along which the gate voltage Vg(1, j) that has just been outputted from the scanning signal line drive circuit 120 falls to the gate OFF voltage; and the slope along which the gate voltage Vg(N, j) corresponding to the termination of the scanning signal line falls to the gate OFF voltage. This eliminates the nonuniformity of the level shift over the display surface, thereby allowing high-quality display images to be obtained.

[Patent Document 1] Japanese Unexamined Patent Application Publication No. 281957/1999 (Tokukaihei 11-281957; published on Oct. 15, 1999)

### DISCLOSURE OF INVENTION

According to the display apparatus disclosed in Patent Document 1, in a case where the slope along which the gate voltage falls is realized, the value of a resistor Rcnt in a slope generating circuit 140 (see FIG. 19) of a drive circuit is determined in accordance with the horizontal length of a display panel.

Unfortunately, the above conventional display apparatus poses the following problem: When a display panel in use is replaced with another display panel having a different horizontal length, it is necessary that the resistor R also be replaced with another resistor having a value in accordance with the horizontal length of such another display panel to be used. This causes a single resistor not to be commonly applicable to display panels having various sizes. It follows that it is necessary to replace a drive circuit board itself, on which a resistor is provided, with another one.

The present invention has been accomplished in view of the above problem. It is an object of the present invention to provide a display apparatus in which a single drive circuit board is commonly applicable to display panels having various sizes.

In order to attain the above object, a display apparatus of the present invention includes a display panel including: a plurality of video signal lines to supply a data signal; a plurality of scanning signal lines provided so as to intersect with the video signal lines; and pixel electrodes provided at intersections of the video signal lines and the scanning signal lines via switching elements, respectively; a scanning signal line drive circuit for supplying a scanning signal to each of the scanning signal lines, and falling slope signal generating means for generating a falling slope signal for controlling the scanning signal so that the scanning signal falls along a slope, and for supplying the falling slope signal to the scanning signal line drive circuit; the falling slope signal generating means including changing means for changing timing of a rising edge of the scanning signal and timing of a slope falling edge of the scanning signal.

In order to attain the above object, a display apparatus of the present invention includes a display panel including: a plurality of video signal lines to supply a data signal; a plurality of scanning signal lines provided so as to intersect with the video signal lines; and pixel electrodes provided at intersections of the video signal lines and the scanning signal lines via switching elements, respectively; a scanning signal line drive circuit for supplying a scanning signal to each of the scanning signal lines, and falling slope signal generating means for generating a falling slope signal in accordance with a signal delay transfer characteristic of a scanning signal line, and for supplying the falling slope signal to the scanning signal line drive circuit, the characteristic being inherent in the scanning signal line due to a length of the display panel, the falling slope signal being generated for controlling the scanning signal so that the scanning signal falls along a substantially equal slope regardless of its position on the scanning signal line, the falling slope signal generating means including storing means for variably setting timing of a rising edge of the scanning signal and timing of a slope falling edge of the scanning signal.

According to the above invention, the falling slope signal generating means generates a falling slope signal in accordance with a signal delay transfer characteristic of a scanning signal line, and supplies the falling slope signal to the scanning signal line drive circuit, the characteristic being inherent in the scanning signal line due to a length of the display panel, the falling slope signal being generated for controlling the scanning signal so that the scanning signal falls along a substantially equal slope regardless of its position on the scanning signal line.

It is indeed possible to, for example, mount on the circuit board a resistor having a value set suitably for the signal delay transfer characteristic of the scanning signal lines, the characteristic being determined by the length of the display panel of a given size.

However, since display panels of different sizes have different signal delay transfer characteristics of scanning signal lines, respectively, it has conventionally been necessary that a drive circuit board itself be replaced with another drive circuit board on which a resistor having a value which is in accordance with the signal delay transfer characteristics of the liquid crystal display panels.

In contrast, according to the present invention, the falling slope signal generating means includes changing means for changing timing of a rising edge of the scanning signal and timing of a slope falling edge of the scanning signal.

The falling slope signal generating means favorably includes storing means for variably setting timing of a rising edge of the scanning signal and timing of a slope falling edge of the scanning signal.

It has already been demonstrated that the gradient of the slope of a scanning signal can be changed by controlling the ON period of the scanning signal.

In view of this, it is unnecessary to switch from one drive circuit board to another one on which a resistor is mounted in accordance with the signal delay transfer characteristic of a display panel, by allowing the storing means, which sets the timing of the rising edge of a scanning signal and the timing of the slope falling edge of the scanning signal each for setting the ON period of the scanning signal, to change the respective timing thus set by which timings the ON period of the scanning signal is set, the storing means is arranged so that its settings for such timings can be changed. In other words, it is possible to change the timing of the rise of the scanning signal and the timing of the slope fall of the scanning signal while using a single drive circuit board.

This allows provision of a display apparatus in which a single drive circuit board is commonly applicable to display panels having various sizes.

The display apparatus of the present invention may preferably be arranged such that each of the switching elements is a thin film transistor; and the falling slope signal generating means includes: a control section for outputting an ON/OFF selection signal representing the timing of the rising edge of the scanning signal and the timing of the slope falling edge of the scanning signal; and a gate voltage generating section for (i) supplying a gate ON voltage to a scanning signal line, via the scanning signal line drive circuit, in response to an ON signal of the ON/OFF selection signal, the ON signal representing the timing of the rising edge of the scanning signal, and for (ii) causing charge, stored in the scanning signal line due to the gate ON voltage, to be discharged in response to an OFF signal of the ON/OFF selection signal, the OFF signal representing the timing of the slope falling edge of the scanning signal.

As a result, the display apparatus of the present invention may be arranged such that the control section outputs an ON/OFF selection signal representing the timing of the rising edge of the scanning signal and the timing of the slope falling edge of the scanning signal, and that the gate voltage generating section (i) supplies a gate ON voltage to a scanning signal line in response to an ON signal of the ON/OFF selection signal from the control section, the ON signal representing the timing of the rising edge of the scanning signal, and (ii) causes charge, stored in the scanning signal lines due to the gate ON voltage, to be discharged in response to an OFF signal of the ON/OFF selection signal from the control section, the OFF signal representing the timing of the slope falling edge of the scanning signal. This allows a falling slope signal to be generated.

More specifically, the above allows generating a falling slope signal for controlling a scanning signal so that the scanning signal falls along a substantially equal slope regardless of its position on the scanning signal line.

The display apparatus of the present invention may preferably be arranged such that the gate voltage generating section discharges the charge so that the scanning signal line has a ground potential when the charge stored in the scanning signal line due to the gate ON voltage is discharged in response to the OFF signal of the ON/OFF selection signal so that the scanning signal lines have a ground potential.

According to the above arrangement, it is only necessary that the scanning signal lines be grounded (GND) so that the charge stored by the scanning signal lines due to the gate ON voltage is discharged. This allows the gate voltage generating section to have a simple structure.

The display apparatus of the present invention may preferably be arranged such that the gate voltage generating section includes a discharge potential setting section for setting a potential which will be held by the scanning signal line after the charge stored in the scanning signal line due to the gate ON voltage is discharged in response to the OFF signal of the ON/OFF selection signal.

This allows the discharge potential setting section to set the potential which will be held by the scanning signal lines after electricity stored in the scanning signal lines due to the gate ON voltage is discharged. As a result, it is possible to change the gradient of the slope.

The display apparatus of the present invention may preferably be arranged such that each of the switching elements is a thin film transistor; and the falling slope signal generating means includes: a control section for outputting an ON/OFF selection signal representing the timing of the rising edge of the scanning signal and the timing of the slope falling edge of the scanning signal; and a slope voltage control section for (i) supplying a slope control voltage, obtained by charging a gate ON voltage, to a scanning signal line, via the scanning signal line drive circuit, in response to an ON signal of the ON/OFF selection signal, the ON signal representing the timing of the rising edge of the scanning signal, and for (ii) causing the slope control voltage to be zero by discharging charge, which has been stored due to the gate ON voltage, which is stored due to the gate ON voltage, in response to an OFF signal of the ON/OFF selection signal, the OFF signal representing the timing of the slope falling edge of the scanning signal.

As a result, the display apparatus of the present invention may be arranged such that a control section outputs an ON/OFF selection signal representing the timing of the rising edge of the scanning signal and the timing of the slope falling edge of the scanning signal, and that a slope voltage control section for (i) supplying a slope control voltage, obtained by charging a gate ON voltage, to a scanning signal line, via the scanning signal line drive circuit, in response to an ON signal of the ON/OFF selection signal from the control section, the ON signal representing the timing of the rising edge of the scanning signal, and for (ii) causing the slope control voltage to be zero by discharging stored charge in response to an OFF signal of the ON/OFF selection signal from the control section, the OFF signal representing the timing of the slope falling edge of the scanning signal. This allows a falling slope signal to be generated.

More specifically, the above allows generating a falling slope signal for controlling a scanning signal so that the scanning signal falls along a substantially equal slope regardless of its position on the scanning signal lines.

The display apparatus of the present invention may preferably be arranged such that the display panel is a liquid crystal display panel.

This allows provision of a liquid crystal display apparatus having a drive circuit board capable of being generalized with respect to display panels of various sizes.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram illustrating an arrangement of a slope generating circuit in a liquid crystal display apparatus in accordance with an embodiment of the present invention.

FIG. 2 is a plan view illustrating an entire arrangement of the liquid crystal display apparatus.

FIG. 3 is a block diagram illustrating an arrangement of a scanning signal line drive circuit of the liquid crystal display apparatus.

FIG. 4 is an explanatory view demonstrating that TFTs in a liquid crystal display panel in the liquid crystal display apparatus are not perfect ON/OFF switches, but have a linear gate voltage-drain current characteristic.

FIG. 5 is a waveform diagram illustrating (i) a waveform of a scanning signal in the vicinity of an input of a scanning signal line of the liquid crystal display panel, (ii) a waveform of a scanning signal in the vicinity of a termination of a scanning signal line of the liquid crystal display panel, and (iii) pixel potentials corresponding to the above two waveforms, respectively.

FIG. 6 is a block diagram illustrating an arrangement of another slope generating circuit in the liquid crystal display apparatus.

FIG. 7 is a waveform diagram showing a slope of a scanning signal, generated in the slope generating circuit.

FIG. 8 is a waveform diagram showing a slope of a scanning signal, generated in the slope generating circuit of FIG. 1.

FIG. 9(a) is a view showing the angle of a slope generated when an adjustment resistor in the slope generating circuit has a small value.

FIG. 9(b) is a view showing the angle of a slope generated when an adjustment resistor in the slope generating circuit has a large value.

FIG. 10(a) is a view showing the angle of a slope that would be generated if the liquid crystal display panel were absent.

FIG. 10(b) is a view showing the angle of a slope generated when the liquid crystal display panel has a small capacitance.

FIG. 10(c) is a view showing the angle of a slope generated when the liquid crystal display panel has a large capacitance.

FIG. 11(a) is a view showing the angle of a slope generated when the slope generating circuit has a short slope-generation period.

FIG. 11(b) is a view showing the angle of a slope generated when the slope generating circuit has a long slope-generation period.

FIG. 12 is a block diagram illustrating an arrangement of a modification of the slope generating circuit in the liquid crystal display apparatus.

FIG. 13 is a plan view illustrating an arrangement of a conventional liquid crystal display apparatus.

FIG. 14 is a waveform diagram illustrating drive waveforms obtained in the liquid crystal display apparatus.

FIG. 15 is a waveform diagram illustrating how a scanning signal fed from a scanning signal line drive circuit into a scanning signal line of the liquid crystal display apparatus is distorted in a panel due to a signal delay transfer characteristic of the scanning signal line.

FIG. 16 is a circuit diagram of an equivalent circuit showing signal transfer delay occurring when a signal is propagated through a specific one of the scanning signal lines.

FIG. 17 is a circuit diagram illustrating an equivalent circuit of a display pixel having an arrangement in which a pixel capacitance and an auxiliary capacitance in the liquid crystal display apparatus are connected in parallel with a counter potential of a counter electrode drive circuit.

FIG. 18 is a waveform diagram illustrating how a scanning signal fed from a scanning signal line drive circuit into the scanning signal line is distorted in a panel due to a signal delay transfer characteristic of the scanning signal line.

FIG. 19 is a block diagram illustrating an arrangement of a slope generating circuit serving as a drive circuit in the liquid crystal display apparatus.

### DESCRIPTION OF THE REFERENCE CODES

2 TFT (switching element; thin film transistor)

3 pixel electrode

10 liquid crystal display panel (display panel)

20 scanning signal line drive circuit

23 scanning signal line

30 signal line drive circuit

31 video signal line

40 slope generating circuit (falling slope signal generating means)

50 slope generating circuit (falling slope signal generating means)

51 control circuit (T-CON; control section, discharge potential setting section)

52 EEPROM (changing means, storing means)

Ccnt capacitor (gate voltage generating section)

GSLOPE output signal

INV inverter (gate voltage generating section)

R1 adjustment resistor (resistor)

Rcnt resistor (gate voltage generating section)

SW1, SW2 switch (gate voltage generating section)

TR1 transistor

TR2 transistor

Vgl gate OFF voltage

Vgh gate ON voltage

### BEST MODE FOR CARRYING OUT THE INVENTION

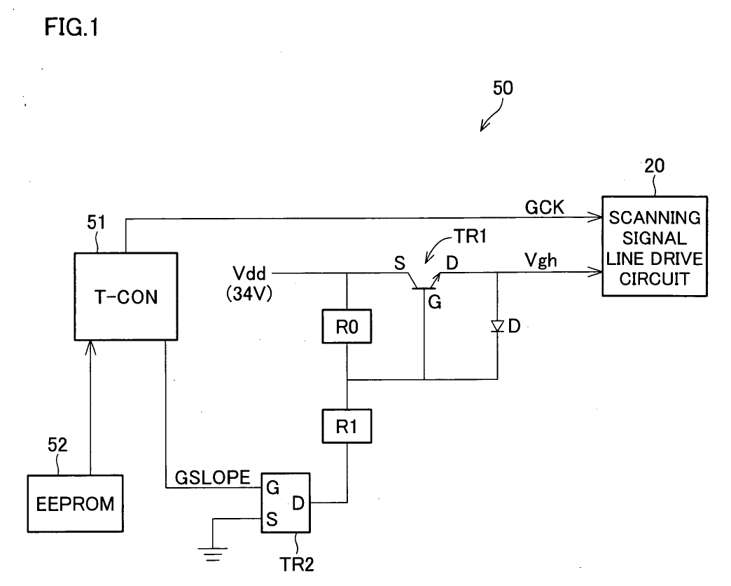

One embodiment of the present invention is described below with reference to FIGS. 1 through 12.

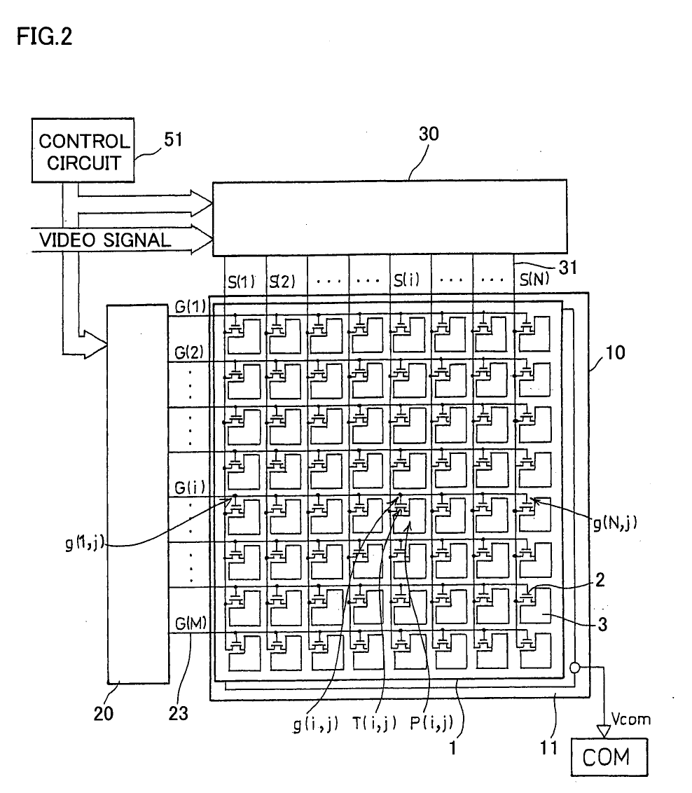

As illustrated in FIG. 2, a liquid crystal display apparatus of the present embodiment includes as main sections: a liquid crystal display panel 10 serving as a display panel; and a drive circuit section. The liquid crystal display panel 10 includes: a pair of electrode substrates; a liquid crystal composition held between the pair of electrode substrates; and a polarizing plate attached to an outer surface of each of the electrode substrates.

One of the electrode substrates is a thin film transistor (TFT) array substrate which includes a transparent insulating substrate 1 made of a material such as glass. Provided on the transparent insulating substrate 1 are (i) a plurality of signal lines S(1), S(2), . . . S(i), . . . and S(N) and (ii) a plurality of scanning signal lines G(1), G(2), . . . G(j), . . . and G(M), in a matrix manner, and (iii) TFTs 2, serving as a switching element, which are connected to pixel electrodes 3 and which are provided at intersections of the signal lines and the scanning signal lines, respectively. The above constituent members are substantially entirely covered with an alignment film (not shown). The TFT array substrate is thus formed.

The other electrode substrate is a counter substrate which includes a transparent insulating substrate made of a material such as glass, like the TFT array substrate. The counter substrate further includes a counter electrode 11 and an alignment film (not shown) which are stacked in this order over the entire transparent insulating substrate. The above drive circuit section includes a scanning signal line drive circuit 20, a signal line drive circuit 30, and a counter electrode drive circuit COM which are connected to the scanning signal lines, the signal lines, and the counter electrode, respectively, of the liquid crystal display panel 10 which is arranged as above and serves as a display panel.

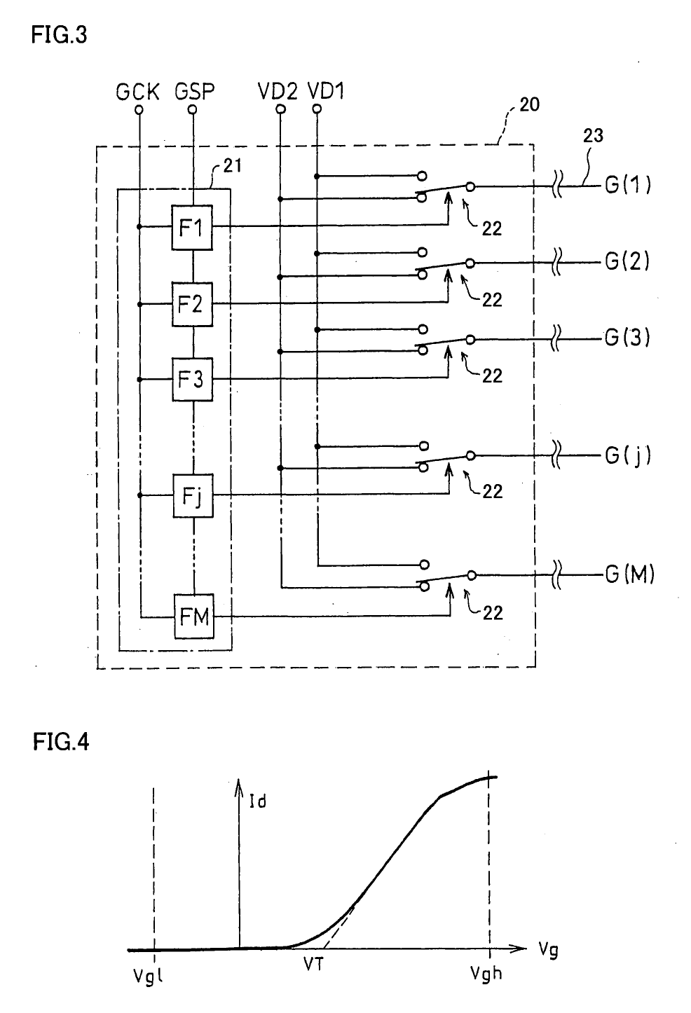

As illustrated in FIG. 3, the scanning signal line drive circuit 20 includes, for example: a shift register section 21 including M flip-flops connected in a cascade manner; and selecting switches 22 which perform switching in response to outputs from the flip-flops, respectively.

One input terminal VD1 of each of the selecting switches 22 is provided with a gate ON voltage Vgh which is sufficient to turn on a TFT 2, whereas the other terminal VD2 is provided with a gate OFF voltage Vgl which is sufficient to turn off the TFT 2. In sync with a clock signal (SCK), a data signal (GSP) is sequentially transferred through the flip-flops and is sequentially supplied to the selecting switches 22. In response to the data signals, the selecting switches 22, during one scanning period (TH), select the gate ON voltage Vgh for turning on the TFTs 2 to be supplied to the scanning signal lines 23, respectively. Subsequently, the gate OFF voltage Vgl for turning off the TFTs 2 is supplied to the scanning signal lines 23, respectively. This operation allows video signals supplied from the signal line drive circuit 30 to the video signal lines 31 to be written into the pixels, respectively.

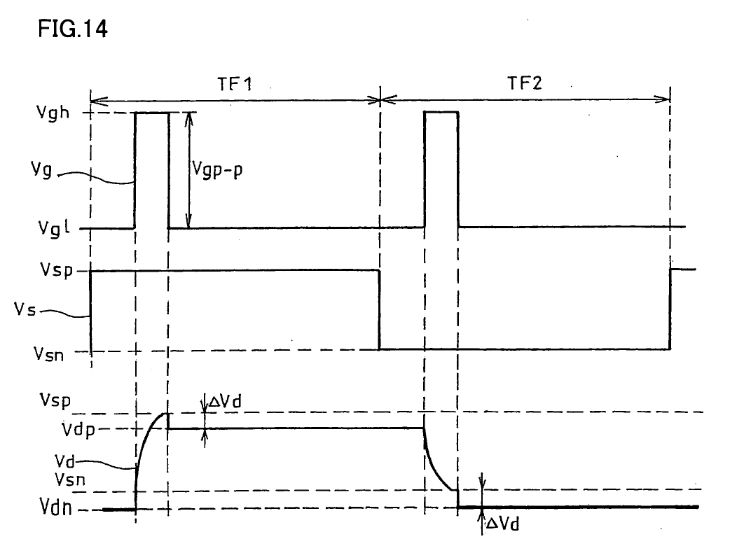

The following description deals in detail with a conventional method for driving a liquid crystal display apparatus having the above arrangement, with reference to FIGS. 14, 17, and other drawings. FIG. 14 is a waveform diagram illustrating drive waveform obtained in a conventional liquid crystal display apparatus. In FIG. 14, Vg is voltage waveform of a scanning signal line; Vs is voltage waveform of a signal line; and Vd is drain waveform. FIG. 17 is an equivalent circuit diagram of a display pixel P(i, j) in which pixel capacitance Clc and auxiliary capacitance Cs are connected in parallel with a counter potential VCOM of the counter electrode drive circuit COM. In FIG. 17, Cgd represents parasitic capacitance between the gate and the drain of the TFT. Note that the present embodiment employs the same equivalent circuit configuration as the display pixel P(i, j). In addition, it is widely known that liquid crystal display apparatuses require AC driving so that screen burn-in and deterioration in display quality are prevented. In view of this, the following description deals with a driving method adopting a frame inversion driving, which is a type of the AC driving.

As shown in the explanatory view of FIG. 14 illustrating the conventional driving method, during a first field (TF1), a TFT of a display pixel P(i, j) is changed into an ON state when a gate ON voltage Vgh is applied from the scanning signal line drive circuit to a gate electrode g(i, j) of the TFT (see FIG. 14). This causes a video signal voltage Vsp of the signal line drive circuit to be written into a corresponding pixel electrode, via a source electrode and a drain electrode of the TFT. The pixel electrode maintains a pixel potential Vdp until a gate ON voltage Vgh is applied to the TFT during the following field (TF2). The counter electrode is set to a predetermined counter potential VCOM by the counter electrode drive circuit COM. As a result, the liquid crystal composition held between the pixel electrode and the counter electrode responds to a potential difference between the pixel potential Vdp and the counter potential VCOM, whereby displaying of an image is carried out.

Similarly, during a second field (TF2), the TFT of the display pixel P(i, j) is changed into the ON state when the gate ON voltage Vgh is applied from the scanning signal line drive circuit to the gate electrode g(i, j) of the TFT. This causes a video signal voltage Vsn of the signal line drive circuit to be written into the corresponding pixel electrode. The pixel electrode maintains a pixel potential Vdn. As a result, the liquid crystal composition responds to a potential difference between the pixel potential Vdn and the counter potential VCOM, whereby displaying of an image is carried out. An AC driving of the liquid crystal is thus carried out.

As shown in FIG. 17, between the gate and the drain of the TFT, there is inevitably generated a parasitic capacitance Cgd due to the arrangement of the TFT. As shown in FIG. 14, the parasitic capacitance Cgd causes a level shift ΔVd in the pixel potential Vd at a falling edge of the gate ON voltage Vgh. The level shift ΔVd in the pixel potential Vd, caused by the parasitic capacitance Cgd which is inevitably generated in the TFT, is defined by the following equation:

ΔVd=Cgd·(Vgh−Vgl)/(Clc+Cs+Cgd),

wherein Vgl represents a gate OFF voltage, which is a non-scanning voltage of the scanning signal (i.e., a voltage for causing the TFT to be in an OFF state). The level shift ΔVd gives rise to a problem of such defects as flickers and quality deterioration in display images. Thus, such a problem due to the above level shift is quite unfavorable to liquid crystal display apparatuses, which are expected to achieve higher resolution and higher display quality.

The scanning signal lines G(1), G(2), . . . G(j), . . . and G(M) in FIG. 2, formed on the transparent insulating substrate 1 made of a material such as glass, are difficult to form with ideal wires which cause no signal delay transfer, and therefore are signal delay paths in which signal transfer delay occurs to some extent.

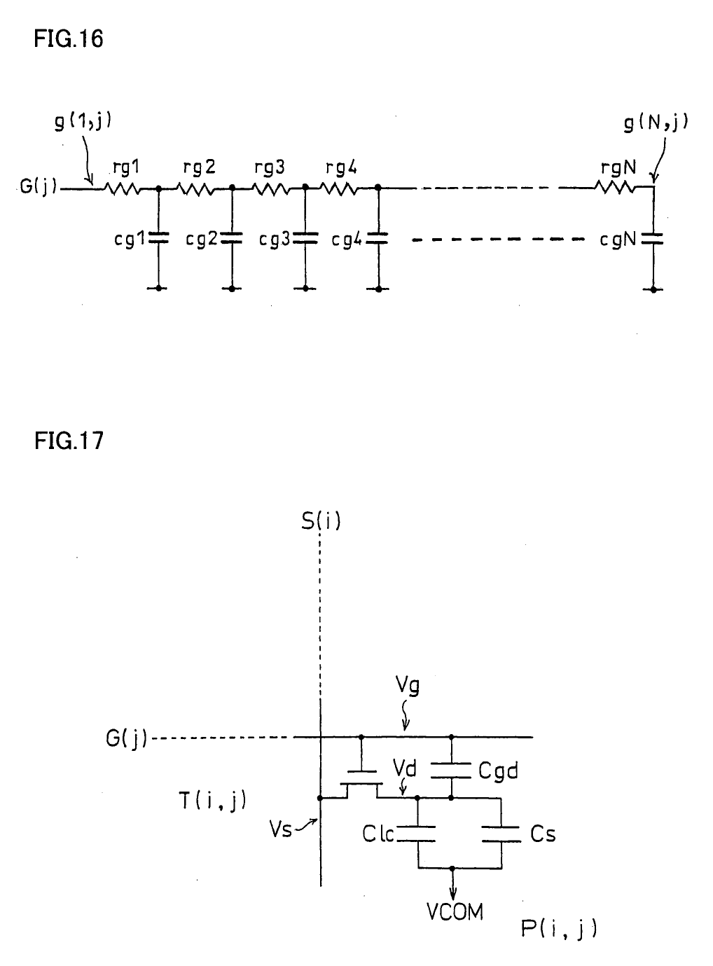

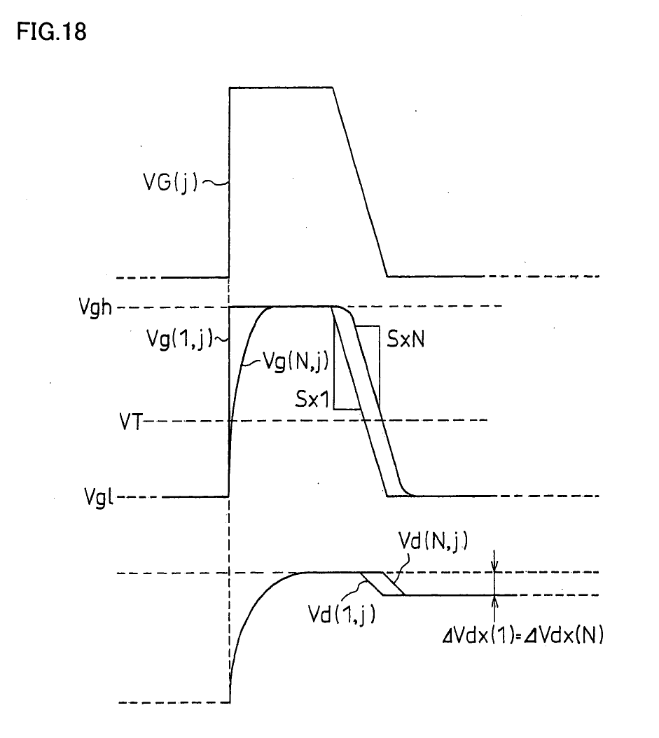

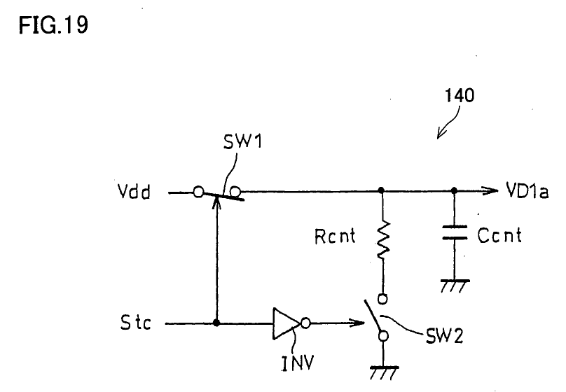

Specifically, as shown in FIG. 16 illustrating the conventional arrangement, there mainly exist, in each of the scanning signal lines G(1), G(2), . . . G(j), . . . and G(M), (i) resistance components rg1, rg2, rg3, . . . , and rgN which depend on the material, the width, and the length of the wires from which the scanning signal lines are formed, and (ii) various parasitic capacitance cg1, cg2, cg3, . . . and cgN which are formed, for example, by capacitance such as cross capacitance generated due to the intersections of the scanning signal lines and the signal lines, respectively, and which are capacitively coupled to the scanning signal lines, respectively. As such, the scanning signal lines provide distributed constant signal delay transfer paths, respectively. This indicates that the transfer of a scanning signal is delayed in proportion to a length of the liquid crystal display panel 10 in a direction parallel to a direction in which a scanning signal line extends.

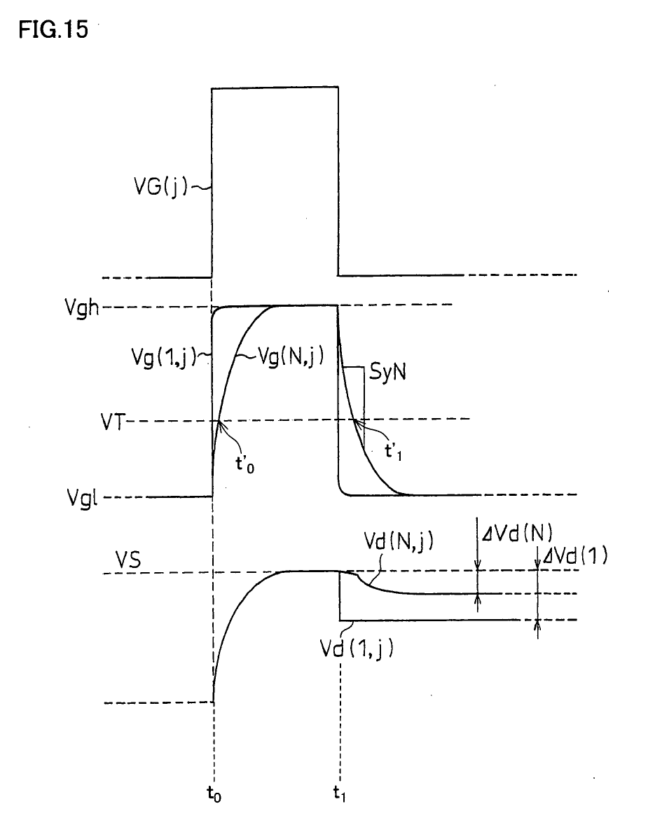

In consequence, as shown in FIG. 15 illustrating the conventional waveform, a scanning signal VG(j), applied to the scanning signal line by the scanning signal line drive circuit, is distorted in the panel due to the above-mentioned signal delay transfer characteristic of the scanning signal lines. More specifically, in FIG. 15, the waveform of Vg(1, j) is of a signal which has just been outputted from the scanning signal line drive circuit and which is thus in the vicinity of g(1, j). This waveform of Vg(1, j) is very little distorted. In contrast, in FIG. 15, the waveform of Vg(N, j) is of a signal in the vicinity of g(N, j) which is a termination of the scanning signal line. This waveform of Vg(N, j) is distorted due to the signal delay transfer characteristic of the scanning signal line. The waveform distortion yields a change amount SyN per unit of time.

Each of the TFTs 2 is not a perfect ON/OFF switch, and has a V-I characteristic (gate voltage-drain current characteristic) illustrated in FIG. 4. In FIG. 4, the horizontal axis represents a voltage applied to the gate of a TFT 2, and the vertical axis represents a drain current. A scanning pulse signal normally has two voltage levels: a gate ON voltage Vgh which is sufficient to turn on the TFT 2; and a gate OFF voltage Vgl which is sufficient to turn off the TFT 2. Practically, however, there exists an intermediate ON region (linear region) between a threshold voltage VT of the TFT 2 and the gate ON voltage Vgh, as illustrated in FIG. 4.

As illustrated in FIG. 15, as to a pixel corresponding to the gate electrode g(1, j) to which an output has just been outputted from the scanning signal line drive circuit 120, a scanning signal falls from the gate ON voltage Vgh to the gate OFF voltage Vgl instantaneously. As such, the scanning signal is unaffected by the linear region characteristic of the TFT, and consequently a level shift ΔVd(1) generated in the pixel potential Vd(1, j) due to the parasitic capacitance Cgd can be approximated by the following formula:

ΔVd(1)=Cgd·(Vgh−Vgl)/(Clc+Cs+Cgd).

In contrast, as to the pixel near g(N, j) which is a termination of the scanning signal line, the falling edge of a scanning signal is distorted, and the scanning signal is therefore affected by the linear region characteristic of the TFT. In consequence, the parasitic capacitance Cgd causes no level shift in the pixel potential Vd while the scanning signal falls from the gate ON voltage Vgh to the vicinity of the threshold voltage VT of the TFT because the TFT is then linearly in the ON state. In contrast, the parasitic capacitance Cgd does cause a level shift ΔVd(N) in the pixel potential Vd(N, j), while the scanning signal further falls from the vicinity of the threshold voltage VT to the gate OFF voltage Vgl. Therefore, the level shift ΔVd(N) is defined by the following inequality:

ΔVd(N)<Cgd·(Vgh−Vgl)/(Clc+Cs+Cgd),

whereby ΔVd(1)>ΔVd(N) is satisfied.

As described above, the level shift ΔVd generated in the pixel potential Vd due to the parasitic capacitance Cgd in a liquid crystal display panel is nonuniform over a display surface. This nonuniformity cannot be ignored when the screen is larger and has a higher resolution. A conventional method of biasing a counter voltage is incapable of absorbing the nonuniformity of the level shift over a display surface and therefore does not allow an optimal AC driving of each pixel to be carried out. This gives rise to defects such as occurrence of flickers and screen burn-in caused by an application of a DC component.

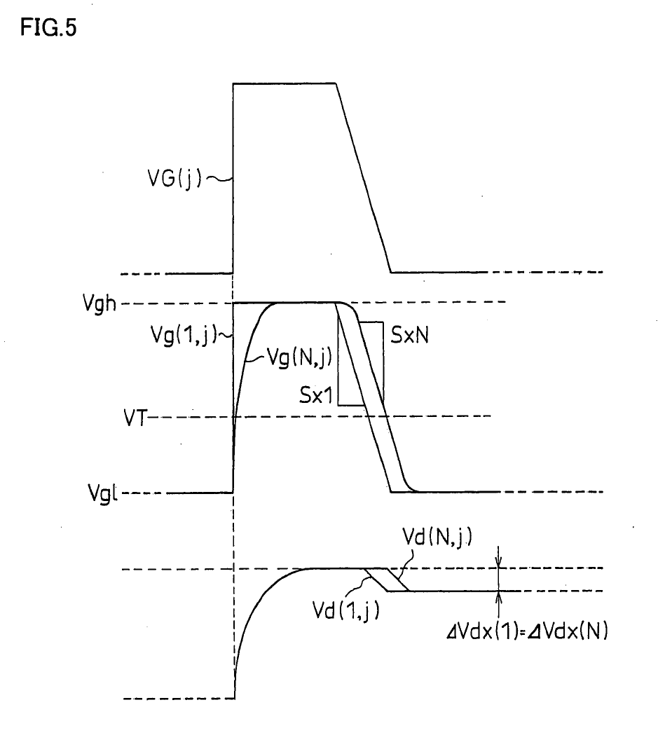

As illustrated in FIG. 5, according to the liquid crystal display apparatus of the present embodiment, a gate voltage Vg(1, j) of the gate electrode g(1, j) that has just been outputted from the scanning signal line drive circuit 20 is designed so as to intentionally fall along a slope of its falling edge to the gate OFF voltage. This allows the following two slopes to be substantially identical to each other: the slope along which the gate voltage Vg(1, j) that has just been outputted from the scanning signal line drive circuit 20 falls to the gate OFF voltage; and the slope along which the gate voltage Vg(N, j) corresponding to the termination of the scanning signal line falls to the gate OFF voltage. This eliminates the nonuniformity of the level shift over the display surface, thereby allowing high-quality display images to be obtained.

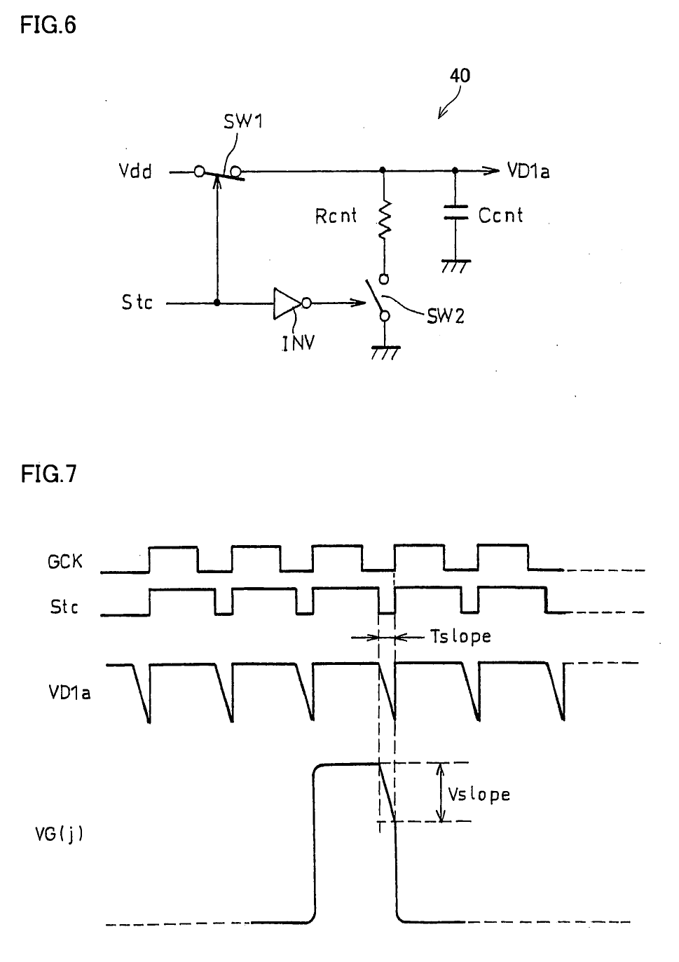

The following description deals in detail with the above principle with reference to FIGS. 5 and 6. FIG. 5 shows: waveform of outputs VG(j−1), VG(j), and VG(j+1) that are outputted from the scanning signal line drive circuit 20; waveform of a scanning signal Vg(1, j) in the vicinity of the input of a scanning signal line; waveform of a scanning signal Vg(N, j) in the vicinity of a termination of the scanning signal line; and pixel potentials, Vd(1, j) and Vd(N, j) corresponding to Vg(1, j) and Vg(N, j), respectively.

As shown in FIG. 5, in the present embodiment, the waveform of the output VG(j) that is outputted from the scanning signal line drive circuit 20 is changed so that it falls from the gate ON voltage Vgh to the gate OFF voltage Vgl along a slope corresponding to the change amount Sx per unit of time.

In the display method in which display is carried out by (i) supplying data signals into the plurality of pixel electrodes 3 via the video signal lines 31, respectively, and (ii) supplying scanning signals into the scanning signal lines 23 intersecting with the video signal lines 31, respectively, the falling edge of each of the scanning signals is controlled during the driving. Such falling edge can be achieved by arbitrarily setting the change amount Sx.

Like the waveform of the scanning signals Vg(1, j) and Vg(N, j), proper setting of the change amount Sx causes (i) a change amount Sx1 in the vicinity of the input of a scanning signal line 23, and (ii) a change amount SxN in the vicinity of the termination of the scanning signal line 23, to be substantially equal to each other. This is because the scanning signal is unaffected by the signal delay transfer characteristic which the scanning signal lines 23 inherently has.

This causes the level shift in the pixel potential Vd caused by the parasitic capacitance Cgd, which the scanning signal lines 23 parasitically has, to be substantially uniform over the display surface. In consequence, it is possible to provide a display apparatus in which flickers are reduced sufficiently and a display defect such as residual image due to screen burn-in is eliminated, by adopting a conventional method in which, for example, a bias potential of VCOM (a counter potential) is applied to the counter electrode 11 so that a level shift ΔVd caused by the parasitic capacitance Cgd is reduced in advance.

When the change amounts Sx1 and SxN are caused to be substantially equal to each other during the falling edges as described above regardless of their positions on the scanning signal line 23, the falling edge of a scanning signal should be controlled in accordance with the signal delay transfer characteristic of the scanning signal line 23. The above control allows the scanning signal to fall along a substantially equal slope at any point on the scanning signal line 23, thereby causing level shifts in the pixel potentials to be substantially equal to one another.

The following description deals with a method for forming the slope.

As shown in FIG. 3, the scanning signal line drive circuit 20 is supplied with the gate ON voltage Vgh and the gate OFF voltage Vgl. The gate ON voltage Vgh is selected during one scanning period (TH), so that (i) it is supplied sequentially to a scanning signal line 23 and (ii) the gate OFF voltage Vgl for turning off the. TFTs is then supplied to the scanning signal line 105, in sync with the gate clock signal GCK. For the purpose of forming a slope, the present embodiment employs, as an example, a slope generating circuit 40, illustrated in FIG. 6, which serves as falling slope signal generating means and which is incorporated in the liquid crystal display apparatus. An output from this circuit is used as the gate ON voltage Vgh for the scanning signal line drive circuit 20.

As illustrated in FIG. 6, the slope generating circuit 40 mainly includes: a resistor Rcnt and a capacitor Ccnt, both used for charging and discharging; an inverter INV used for controlling the charging and the discharging; and switches SW1 and SW2 for switching between the charging and the discharging.

One end of the switch SW1 is supplied with a signal voltage Vdd. The signal voltage Vdd is a DC voltage having a gate ON voltage Vgh which is sufficient to turn on a TFT 2.

The other end of the switch SW1 is connected to one end of the resistor Rcnt and to one end of the capacitor Ccnt. Note that the resistor Rcnt and the capacitor Ccnt are set in accordance with the horizontal length of the liquid crystal display panel 10, i.e., the length in a direction parallel to the scanning signal lines 23.

The other end of the resistor Rcnt is grounded (GND) via the switch SW2. Switching of the switch SW2 is controlled in accordance with an Stc signal which serves as an ON/OFF selection signal and which is supplied, via the inverter INV, from a control circuit 51 (later described) serving as a control section. The Stc signal is in sync with one scanning period, and the switching of the switch SW1 is also controlled in accordance with the Stc signal. As illustrated in FIG. 7, the Stc signal is required to be generated so as only to be in sync with the clock signal (GCK). The Stc signal can be generated by using a mono multivibrator (not shown) or the like, for example. The resistor Rcnt, the capacitor Ccnt, the inverter INV, and the switches SW1 and SW2, function as a gate voltage generating section.

The following description deals with switching operations of the switches SW1 and SW2.

While the Stc signal has a high level, the switch SW1 is in a closed state, whereas the switch SW2, which is supplied with the Stc signal having a low level via the inverter INV, is in an open state. In contrast, when the Stc signal has a low level (discharge control signal), the switch SW1 is in the open state, whereas the switch SW2, which is supplied with the Stc signal having a high level via the inverter INV, is in the closed state. In other words, the switches SW1 and SW2 are high active elements in the arrangement illustrated in FIG. 6.

The slope generating circuit 40 generates an output signal VD1a, which is supplied to the input terminal VD1 of the scanning signal line drive circuit 20 illustrated in FIG. 3. As shown in FIG. 7, the Stc signal is a timing signal for controlling the falling period of the gate voltage, and has a cycle equal to one scanning period (TH).

With the arrangement, while the Stc signal has a high level, the switches SW1 and SW2 are in the closed and open states, respectively. This causes the output signal VD to be supplied, as a gate ON voltage Vgh, to the input terminal VD1 of the scanning signal line drive circuit 20 illustrated in FIG. 3. In contrast, while the Stc signal has a low level, the switches SW1 and SW2 are in the open and closed states, respectively. This causes charge stored in the capacitor Ccnt to be discharged via the resistor Rcnt, thereby causing the gate voltage level to gradually decrease. As such, the output signal VD1a has sawtooth waveform illustrated in FIG. 7.

When the output signal VD1a is supplied to the input terminal VD1 of the scanning signal line drive circuit 20, it is possible to readily generate a scanning signal having a slope along which the scanning signal falls, as with the scanning signal VG(j) of FIG. 7. The slope period of the scanning signal can be adjusted by changing a low period of the Stc signal: The gradient Vslope can be adjusted by varying the resistor Rcnt and the capacitor Ccnt shown in FIG. 6 so that the time constant of the resistor Rcnt and the capacitor Ccnt is adjusted. This allows optimization of the slope for every liquid crystal display panel 10 to be driven.

In other words, when the horizontal length of the liquid crystal display panel 10 is changed, the shape of the slope is changed, accordingly. As such, it is necessary to vary the resistor Rcnt and the capacitor Ccnt in accordance with the horizontal length of the liquid crystal display panel 10. This necessitates the varying of hardware such as the resistor Rcnt for each liquid crystal display panel 10 to be driven. This in turn prevents, in the production process, parts such as a drive circuit board from being commonly applicable to different liquid crystal display panels.

In view of this, the present embodiment allows the shape of the slope to be changed in accordance with the size of a liquid crystal display panel 10 by means of software change.

With reference to FIG. 1, the following description deals with a driving device of the present embodiment bringing about the effect.

The driving device in the liquid crystal display apparatus of the present embodiment includes a slope generating circuit 50, illustrated in FIG. 1, serving as falling slope signal generating means.

The slope generating circuit 50 includes: a transistor TR1; a diode D; a base resistor R0; an adjustment resistor R1, a transistor TR2; a control circuit 51 serving as a control section; and an EEPROM 52 which serves as changing means and storing means and which is connected to the control circuit 51.

The source of the transistor TR1 and one end of the base resistor R0 are connected to a voltage source (not shown) having a signal voltage Vdd of, for example, 34 V. The drain of the transistor TR1 is connected to one end of the diode D and to the input terminal VD1 of the scanning signal line drive circuit 20 illustrated in FIG. 2.

Each of the other end of the base resistor R0, the gate of the transistor TR1, and the other end of the diode D, is connected to one end of the adjustment resistor R1. The other end of the adjustment resistor R1 is connected to the drain D of the transistor TR2. The gate of the transistor TR2 is connected to the control circuit 51, while the source S of the transistor TR2 is grounded (GND).

In the slope generating circuit 50 having the arrangement, when an output signal GSLOPE having a LOW level is supplied from the control circuit 51 to the transistor TR2, no current flows between the source and the drain in the transistor TR2. This causes the transistor TR1 to turn on and causes current to flow between the source and the drain in the transistor TR1. The voltage source supplies, as an output signal VD1a, a gate ON voltage Vgh of, for example, 34 V (a signal voltage Vdd) to the input terminal VD1 of the scanning signal line drive circuit 20 connected to the liquid crystal display panel 10. Consequently, a constant level part of the output signal VD1a is outputted (see FIG. 7).

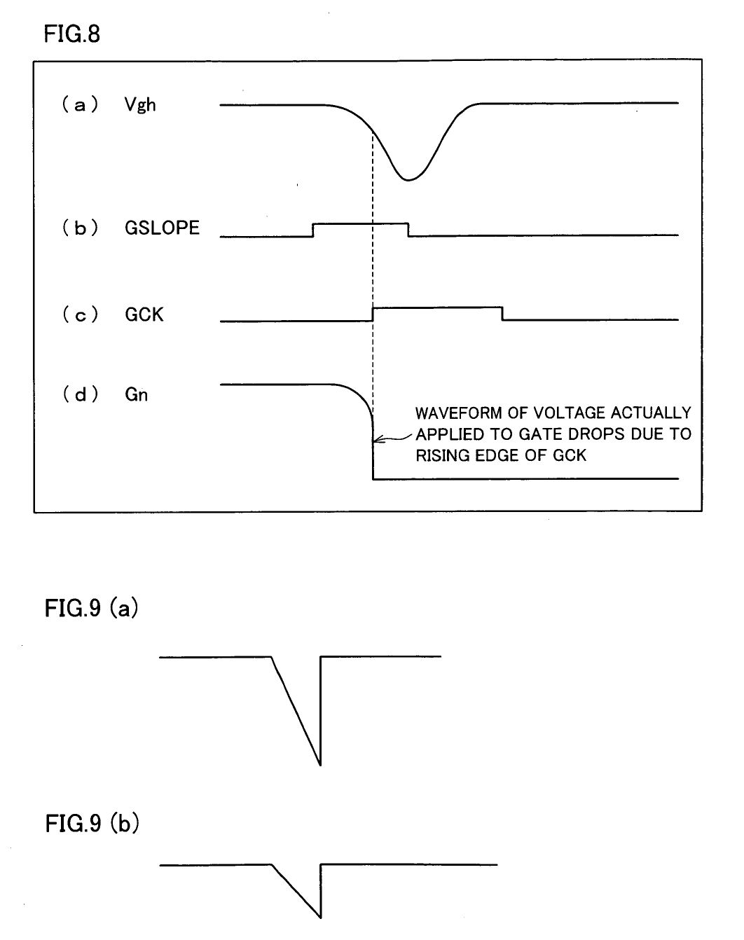

After a predetermined period of time elapses, the control circuit 51 (see FIG. 1) supplies the output signal GSLOPE having a HIGH level, to the transistor TR2. This causes current to flow between the source and the drain in the transistor TR2. Since the source of the transistor TR2 is caused to be grounded, the drain of the transistor TR2 becomes grounded as well. This causes a potential difference to be generated across the adjustment resistor R1, thereby causing the transistor TR1 to turn off. As such, the liquid crystal display panel 10 is connected to the ground (GND), via the diode D and the adjustment resistor R1, so that current flows from the liquid crystal display panel 10 into the ground. This in turn causes a gradual decrease in the potential of the liquid crystal display panel 10, thereby obtaining slope waveform of the gate ON voltage Vgh (see (a) of FIG. 8). The slope waveform of the gate ON voltage Vgh is caused to abruptly drops in sync with a rising edge of the gate clock signal GCK (see (a) through (d) of FIG. 8). When supplying the output signal VD 1a to the input terminal VD1 of the scanning signal line drive circuit 20, it is possible to readily generate a scanning signal which has a slope along which the scanning signal falls (see the scanning signal VG(j) in FIG. 7).

As illustrated in (a) through (d) of FIG. 8, the slope curve of the gate ON voltage Vgh varies depending on the adjustment resistor R1, the capacitance of the liquid crystal display panel 10, and the periods of the output signal GSLOPE.

The following description deals in detail with each of the factors critical to the slope curve of the gate ON voltage Vgh. First described is how the slope changes in accordance with the adjustment resistor R1.

As to the adjustment resistor R1, the current flowing across the adjustment resistor R1 is adjusted. It follows that a rate of change in the gate voltage is adjusted. Thus, a low value of the adjustment resistor R1 results in a large current flowing from the liquid crystal display panel 10, thereby causing the slope to have a steep gradient (see FIG. 9(a)). In contrast, a high value of the adjustment resistor R1 results in a small current flowing from the liquid crystal display panel 10, thereby causing the slope to have a gentle gradient (see FIG. 9(b)).

Next described is how the slope changes in accordance with the capacitance of the liquid crystal display panel 10.

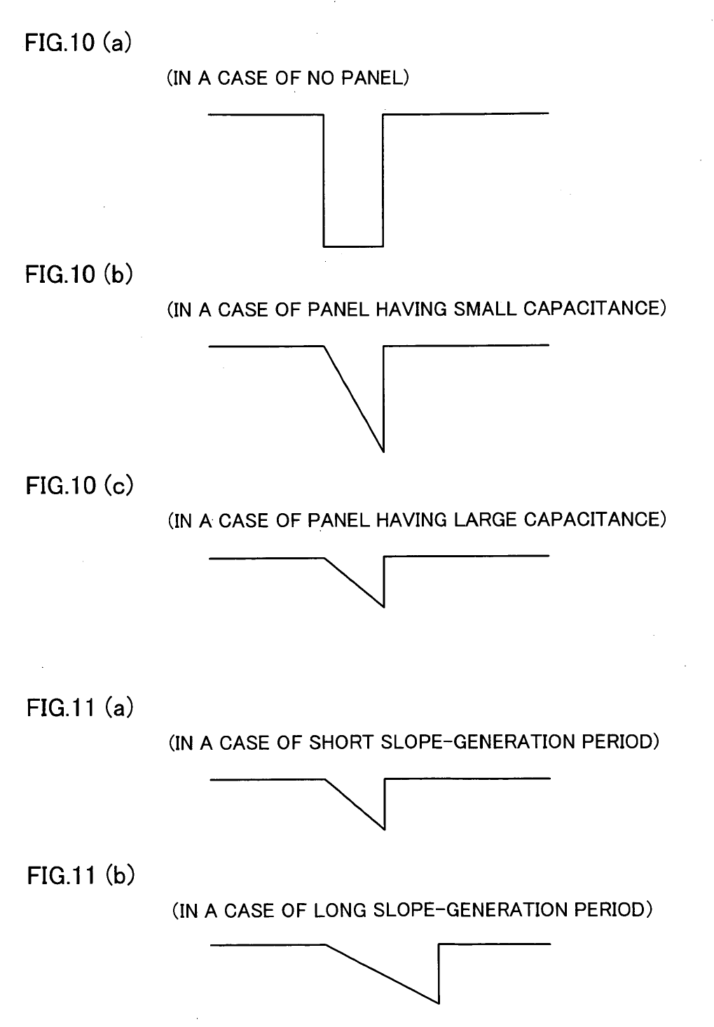

The slope generating circuit 50 generates a slope by causing charge stored in the liquid crystal display panel 10 to be discharged into the ground (GND). As such, in a case where the same current flows to the ground from the liquid crystal display panel 10, the larger capacitance the liquid crystal display panel 10 has, the gentler gradient the slope has. Therefore, if the liquid crystal display panel 10 were absent, then the waveform of the gate ON voltage would be rectangular as illustrated in FIG. 10(a). In a case where the liquid crystal display panel 10 has small capacitance like a 26-inch liquid crystal display panel 10, the slope has a steep gradient as illustrated in FIG. 10(b). In contrast, in a case where the liquid crystal display panel 10 has large capacitance like a 37-inch liquid crystal display panel 10, the slope has a gentle gradient as illustrated in FIG. 10(c).

A change in the size of the liquid crystal display panel 10 causes a change in capacitance, thereby causing a change in the slope curve as described above. It is desirable for the slope curves to be equal to each other under the situation where timing of signal input and driving conditions (e.g., voltages applied to the gate and to the source) are identical to each other. In order for the desire to be met, the adjustment resistor R1 has conventionally been changed in accordance with the size of a liquid crystal display panel 10.

By contrast to this, in the present embodiment, the gradient of the slope is adjusted by changing the slope period, instead of changing the adjustment resistor R1. The following description deals with how the gradient of the slope is changed in accordance with the slope generation period.

The waveform of the gate ON voltage also changes in accordance with the period during which a slope is generated. This phenomenon arises depending on the relationship between the charging period and the discharging period of the liquid crystal display panel 10. For example, when the slope generation period is short, the slope has a steep gradient as illustrated in FIG. 11(a). A short slope-generation period amounts to a long period during which the gate ON voltage Vgh is applied the liquid crystal display panel 10. This causes a comparatively large amount of charge to be stored in the liquid crystal display panel 10.

In a case where (i) the liquid crystal display panel 10 has fixed capacitance and (ii) a large amount of charge is stored in the liquid crystal display panel 10, the charge moves with vigor, and consequently the slope has a slightly steep gradient, as illustrated in FIG. 11(a).

In contrast, a long slope period amounts to a short period during which the gate ON voltage Vgh is applied to the liquid crystal display panel 10. This causes a comparatively small amount of charge to be stored in the liquid crystal display panel 10. In consequence, as illustrated in FIG. 11(b), the slope has a gentle gradient, as contrasted with the slope in FIG. 11(a).

In the present embodiment, a method is adopted in which the slope is adjusted by changing the slope period as described above. One of the advantages of adjusting the slope by changing the slope period is that the slope can be adjusted by changing timing, which is readily digitized, instead of changing a mounted member such as the adjustment resistor R1. Another advantage is that, since the changing of timing amounts to a change in parameter, such a change in parameter can be one of functions which the control circuit 51 can deal with.

More specifically, as illustrated in FIG. 1, the control circuit 51 is arranged to include the EEPROM 52 serving as the storing means. This allows a HIGH period of the output signal GSLOPE to be set in accordance with the gate clock signal GCK generated in the control circuit 51. In other words, the timing at which the output signal GSLOPE rises to a HIGH level and the timing at which the output signal GSLOPE falls to a LOW level are set in accordance with the gate clock signal GCK. As a result, it is possible to change the gradient of the slope as described above.

The adjustment of waveform can be made by setting data digitally. As shown in FIG. 1, data is read out from the EEPROM 52 so that the HIGH period of the output signal GSLOPE is set. With the arrangement, it is possible to deal with liquid crystal display panels 10 of various sizes by only changing the data in the EEPROM 52. For example, it is possible to deal, by use of a single slope generating circuit 50, with any one of a 26-inch liquid crystal display panel 10, a 32-inch liquid crystal display panel 10, and a 37-inch liquid crystal display panel 10. This eliminates the need for changing the circuit board on which the slope generating circuit 50 is mounted. In other words, the slope can be changed without changing a circuit board with another for the purpose of changing the adjustment resistor R1. In addition, even after the slope is changed, the slope can be further changed as desired with ease.

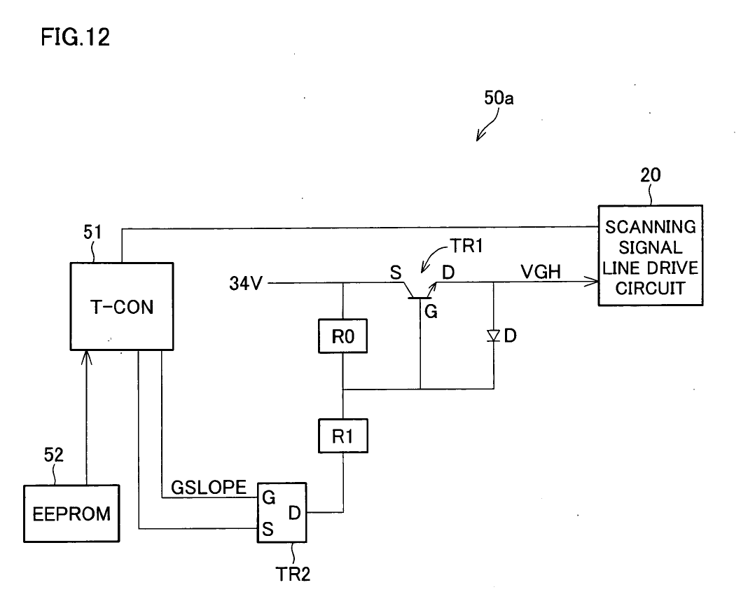

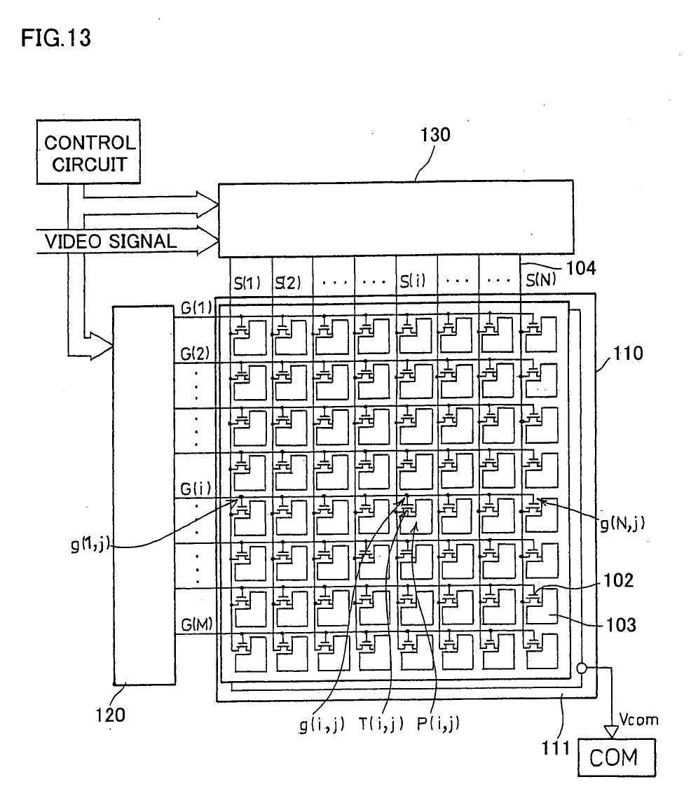

As illustrated in FIG. 1, according to the above description, the source of the transistor TR2 is grounded (GND), and current is caused to flow from the liquid crystal display panel 10 to the ground (GND) so that a slope is generated in the waveform. However, the arrangement is not necessarily limited to this. For example, as illustrated in FIG. 12, the source of the transistor TR2 can receive a variable potential of a digital-to-analog converter (DAC; not shown) in the control circuit 51. Thus, it is possible to form an alternative slope generating circuit 50a, in which the slope is adjusted by changing a voltage of a node to which current flows so that the amount of current flowing into the node is adjusted.

According to the above description, only the slope generating circuit 50 includes the EEPROM 52. However, the arrangement is not necessarily limited to this. The slope generating circuit 40 can also include an EEPROM 52.

As described above, according to the liquid crystal display apparatus of the present embodiment, the slope generating circuits 40 and 50 each generate a falling slope signal in accordance with the signal delay transfer characteristic of a scanning signal line 23, the characteristic being inherent in the scanning signal line 23 due to the length of the liquid crystal display panel 10. The falling slope signal is generated for controlling the scanning signal so that the scanning signal falls along a substantially equal slope regardless of its position on the scanning signal line 23. The falling slope signal is supplied to the scanning signal line drive circuit 20.

It is indeed possible to, for example, mount on the circuit board an adjustment resistor R1 having a value set suitably for a specific signal delay transfer characteristic of the scanning signal lines 23, the characteristic being determined by the length of the liquid crystal display panel 10 of a given size.

However, since liquid crystal display panels 10 of different sizes have different signal delay transfer characteristics of scanning signal lines 23, respectively, it has conventionally been necessary that a circuit board itself be replaced with another circuit board on which an adjustment resistor R1 is mounted which has a value in accordance with the signal delay transfer characteristics of the liquid crystal display panels.

In contrast, according to the present embodiment, the slope generating circuits 40 and 50 each include changing means for changing the timing of the rising edge of a scanning signal and the timing of the slope falling edge of a scanning signal. Specifically, the slope generating circuits 40 and 50 each include the EEPROM 52 for variably setting the timing of the rising edge of the scanning signal and the timing of the slope falling edge of the scanning signal. The EEPROM 52 serving as the changing means can be replaced with other means, e.g., a RAM which serves as storing means and which is included in the control circuit 51. In addition, means, which is arranged by any hardware component so that the timing of the rising edge of the scanning signal and the timing of the slope falling edge of the scanning signal can be changed, and which can be modified within the drive circuit board, can be used in place of the storing means.

In other words, the gradient of the slope of scanning signal can be changed by controlling the ON period of the scanning signal.

In view of this, it is unnecessary to switch from one circuit board to another one on which an adjustment resistor R1 is mounted in accordance with the signal delay transfer characteristic of a liquid crystal display panel 10, by allowing the EEPROM 52, which sets the timing of the rising edge of a scanning signal and the timing of the slope falling edge of the scanning signal each for setting the ON period of the scanning signal, to change the respective timing thus set. The EEPROM 52 is arranged so that its settings for such timings can be changed.

This allows provision of a liquid crystal display apparatus in which a single drive circuit board is commonly applicable to liquid crystal display panels 10 having various sizes.

The liquid crystal display apparatus of the present embodiment is arranged such that the control circuit 51 outputs the Stc signal serving as an ON/OFF selection signal representing the timing of the rising edge of the scanning signal and the timing of the slope falling edge of the scanning signal, and that the gate voltage generating section (i) supplies a gate ON voltage Vgh to a scanning signal line 23 in response to an ON signal of the ON/OFF selection signal from the control circuit 51, the ON signal representing the timing of the rising edge of the scanning signal, and (ii) causes charge, stored in the scanning signal lines 23 due to the gate ON voltage Vgh, to be discharged in response to an OFF signal of the ON/OFF selection signal from the control circuit 51, the OFF signal representing the timing of the slope falling edge of the scanning signal. This allows a falling slope signal to be generated.

More specifically, the above allows generating a falling slope signal for controlling a scanning signal so that the scanning signal falls along a substantially equal slope regardless of its position on the scanning signal line 23.

The liquid crystal display apparatus of the present embodiment is preferably arranged such that the gate voltage generating section discharges the charge so that the scanning signal line has a ground potential when the charge stored in the scanning signal line due to the gate ON voltage Vgh is discharged in response to the OFF signal of the ON/OFF selection signal.

According to the above arrangement, it is only necessary that the scanning signal lines 23 be grounded (GND) so that the charge stored by the scanning signal lines 23 due to the gate ON voltage Vgh is discharged. This allows the gate voltage generating section to have a simple structure.

The liquid crystal display apparatus of the present embodiment is arranged such that the gate voltage generating section includes a control circuit 51 serving as a discharge potential setting section for setting a potential which will be held by the scanning signal line 23 after the charge stored in the scanning signal line 23 due to the gate ON voltage is discharged in response to the OFF signal of the ON/OFF selection signal.

This allows the control circuit 51 to set the potential which will be held by the scanning signal lines 23 after electricity stored in the scanning signal lines 23 due to the gate ON voltage is discharged. As a result, it is possible to change the gradient of the slope.

The liquid crystal display apparatus of the present embodiment is arranged such that the control circuit 51 serving as a control section outputs an Stc signal serving as an ON/OFF selection signal representing the timing of the rising edge of the scanning signal and the timing of the slope falling edge of the scanning signal, and that a slope voltage control section for (i) supplying a slope control voltage, obtained by charging a gate ON voltage Vgh, to a scanning signal line 23, via the scanning signal line drive circuit 20, in response to an ON signal of the Stc signal from the control circuit 51, the ON signal representing the timing of the rising edge of the scanning signal, and for (ii) causing the slope control voltage to be zero by discharging charge, which has been stored due to the gate ON voltage Vgh, in response to an OFF signal of the Stc signal from the control circuit 51, the OFF signal representing the timing of the slope falling edge of the scanning signal. This allows a falling slope signal to be generated.

More specifically, the above allows generating a falling slope signal for controlling a scanning signal so that the scanning signal falls along a substantially equal slope regardless of its position on the scanning signal lines 23.

The display apparatus of the present embodiment is arranged such that the display panel is a liquid crystal display panel. This allows provision of a liquid crystal display apparatus having a drive circuit board capable of being generalized with respect to display panels of various sizes.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to a display apparatus including a display panel and a scanning signal line drive circuit for supplying scanning signals to scanning signal lines. Specifically, examples of such a display apparatus encompass: an active matrix liquid crystal display apparatus; an electrophoretic display; a twisting ball display; a reflective display using a micro prism film; and a display using a light modulation device such as a digital mirror device, in addition to a display using a light-emitting device with a variable luminance such as an organic EL device, an inorganic EL device, and a light-emitting diode (LED), a field emission display (FED), and a plasma display.

1. A display apparatus comprising:
a display panel including:
a plurality of video signal lines to supply a data signal;
a plurality of scanning signal lines provided so as to intersect with the video signal lines; and
pixel electrodes provided at intersections of the video signal lines and the scanning signal lines via switching elements, respectively;
a scanning signal line drive circuit for supplying a scanning signal to each of the scanning signal lines, and
falling slope signal generating means for generating a falling slope signal for controlling the scanning signal so that the scanning signal falls along a slope, and for supplying the falling slope signal to the scanning signal line drive circuit;
the falling slope signal generating means including changing means for changing timing of a rising edge of the scanning signal and timing of a slope falling edge of the scanning signal.

2. A display apparatus comprising:
a display panel including:
a plurality of video signal lines to supply a data signal;
a plurality of scanning signal lines provided so as to intersect with the video signal lines; and
pixel electrodes provided at intersections of the video signal lines and the scanning signal lines via switching elements, respectively;
a scanning signal line drive circuit for supplying a scanning signal to each of the scanning signal lines, and
falling slope signal generating means for generating a falling slope signal in accordance with a signal delay transfer characteristic of a scanning signal line, and for supplying the falling slope signal to the scanning signal line drive circuit, the characteristic being inherent in the scanning signal line due to a length of the display panel, the falling slope signal being generated for controlling the scanning signal so that the scanning signal falls along a substantially equal slope regardless of its position on the scanning signal line,
the falling slope signal generating means including storing means for variably setting timing of a rising edge of the scanning signal and timing of a slope falling edge of the scanning signal.

3. The display apparatus according to claim 1, wherein:
each of the switching elements is a thin film transistor; and
the falling slope signal generating means includes:
a control section for outputting an ON/OFF selection signal representing the timing of the rising edge of the scanning signal and the timing of the slope falling edge of the scanning signal; and
a gate voltage generating section for (i) supplying a gate ON voltage to a scanning signal line, via the scanning signal line drive circuit, in response to an ON signal of the ON/OFF selection signal, the ON signal representing the timing of the rising edge of the scanning signal, and for (ii) causing charge, stored in the scanning signal line due to the gate ON voltage, to be discharged in response to an OFF signal of the ON/OFF selection signal, the OFF signal representing the timing of the slope falling edge of the scanning signal.

4. The display apparatus according to claim 2, wherein:
each of the switching elements is a thin film transistor; and
the falling slope signal generating means includes:
a control section for outputting an ON/OFF selection signal representing the timing of the rising edge of the scanning signal and the timing of the slope falling edge of the scanning signal; and
a gate voltage generating section for (i) supplying a gate ON voltage to a scanning signal line, via the scanning signal line drive circuit, in response to an ON signal of the ON/OFF selection signal, the ON signal representing the timing of the rising edge of the scanning signal, and for (ii) causing charge, stored in the scanning signal line due to the gate ON voltage, to be discharged in response to an OFF signal of the ON/OFF selection signal, the OFF signal representing the timing of the slope falling edge of the scanning signal.

5. The display apparatus according to claim 3, wherein the gate voltage generating section discharges the charge so that the scanning signal line has a ground potential when the charge stored in the scanning signal line due to the gate ON voltage is discharged in response to the OFF signal of the ON/OFF selection signal.

6. The display apparatus according to claim 4, wherein the gate voltage generating section discharges the charge so that the scanning signal line has a ground potential when the charge stored in the scanning signal line due to the gate ON voltage is discharged in response to the OFF signal of the ON/OFF selection signal.

7. The display apparatus according to claim 3, wherein the gate voltage generating section includes a discharge potential setting section for setting a potential which will be held by the scanning signal line after the charge stored in the scanning signal line due to the gate ON voltage is discharged in response to the OFF signal of the ON/OFF selection signal.

8. The display apparatus according to claim 4, wherein the gate voltage generating section includes a discharge potential setting section for setting a potential which will be held by the scanning signal line after the charge stored in the scanning signal line due to the gate ON voltage is discharged in response to the OFF signal of the ON/OFF selection signal.

9. The display apparatus according to claim 1, wherein:
each of the switching elements is a thin film transistor; and
the falling slope signal generating means includes:
a control section for outputting an ON/OFF selection signal representing the timing of the rising edge of the scanning signal and the timing of the slope falling edge of the scanning signal; and
a slope voltage control section for (i) supplying a slope control voltage, obtained by charging a gate ON voltage, to a scanning signal line, via the scanning signal line drive circuit, in response to an ON signal of the ON/OFF selection signal, the ON signal representing the timing of the rising edge of the scanning signal, and for (ii) causing the slope control voltage to be zero by discharging charge, which has been stored due to the gate ON voltage, in response to an OFF signal of the ON/OFF selection signal, the OFF signal representing the timing of the slope falling edge of the scanning signal.

10. The display apparatus according to claim 1, wherein the display panel is a liquid crystal display panel.

11. The display apparatus according to claim 2, wherein:
each of the switching elements is a thin film transistor; and
the falling slope signal generating means includes:
a control section for outputting an ON/OFF selection signal representing the timing of the rising edge of the scanning signal and the timing of the slope falling edge of the scanning signal; and
a slope voltage control section for (i) supplying a slope control voltage, obtained by charging a gate ON voltage, to a scanning signal line, via the scanning signal line drive circuit, in response to an ON signal of the ON/OFF selection signal, the ON signal representing the timing of the rising edge of the scanning signal, and for (ii) causing the slope control voltage to be zero by discharging charge, which has been stored due to the gate ON voltage, in response to an OFF signal of the ON/OFF selection signal, the OFF signal representing the timing of the slope falling edge of the scanning signal.

12. The display apparatus according to claim 2, wherein the display panel is a liquid crystal display panel.
